(19) United States
(12) Patent Application Publication
(10) Pub. No.: US 2026/0307658 A1
(43) Pub. Date: Oct. 8, 2026

(54) APPARATUS AND METHOD FOR ESTIMATING VEHICLE WEIGHT

(71) Applicants: Hyundai Motor Company, Seoul (KR); Kia Corporation, Seoul (KR)

(72) Inventors: Jiwon OH, Hwaseong-Si (KR); Lee Hyoung Cho, Hwaseong-Si (KR)

(73) Assignees: Hyundai Motor Company, Seoul (KR); Kia Corporation, Seoul (KR)

(21) Appl. No.: 19/376,687

(22) Filed: Oct. 31, 2025

(30) Foreign Application Priority Data
Apr. 2, 2025 (KR) 10-2025-0042513

(51) Int. Cl. B60W 40/13; G01G 19/08

(52) U.S. Cl. CPC B60W 40/13; G01G 19/086; B60W 2510/18; B60W 2520/105; B60W 2520/18

(57) ABSTRACT

In an apparatus configured for estimating a vehicle weight using only hardware disposed in a vehicle without using an additional sensor, and a method therefor, the apparatus includes at least one sensor for obtaining vehicle driving information, and a processor, in which a learning model using the vehicle driving information obtained through the at least one sensor as an input variable of the learning model is set, that estimates the vehicle weight using information related to a difference between a vehicle longitudinal motion state value learned by the set learning model and an actual vehicle longitudinal motion state value obtained through the at least one sensor.

### CROSS-REFERENCE TO RELATED APPLICATION

The present application claims, under 35 U.S.C. § 119(a), the benefit of and priority to Korean Patent Application No. 10-2025-0042513 filed on Apr. 2, 2025, the entire contents of which are incorporated herein by reference.

### BACKGROUND

### Technical Field

The present disclosure relates to an apparatus configured for estimating a current vehicle weight using only hardware disposed in the vehicle without use of an additional sensor, and a method therefor.

### Background Art

Vehicle weight information may be used in various ways in vehicle control. In particular, in a case where the vehicle weight information is used for the vehicle control, control performance may be greatly improved. For example, in the case of a truck, in a case where weight information of the truck is used for drive wheel torque control, unnecessary wheel slip may be prevented.

Furthermore, in a case where Electronic Stability Control (ESC) is performed in consideration of the vehicle weight information, electronic stability control performance may be optimized. Furthermore, in a case where the weight information is used for predicting a vehicle driving range, prediction and display of accurate driving range may be achieved.

Furthermore, in a case where variable damper suspension control is performed in consideration of sprung mass information, real-time optimum damping force control may be achieved. Thus, it is possible to adjust a charge and discharge strategy of a drive motor through trailer installation detection, or to adjust control values for load and shift control of a drive unit such as an engine or a motor.

However, to measure the weight of a vehicle, it is necessary to mount a precise sensor in the vehicle, which results in cost increase.

The above information included in this Background section is only for enhancement of understanding of the background of the disclosure and therefore it may include information that does not form the related art which is already known to those skilled in the art.

### SUMMARY OF THE DISCLOSURE

The present disclosure has been made in an effort to solve the above-described problems associated with related art, and it is an aspect of the present disclosure to provide an apparatus configured for estimating a vehicle weight in real time using only hardware disposed in the vehicle without using an additional sensor, and a method therefor.

In particular, it is another aspect of the present disclosure to provide a method for securing stable weight estimation performance under all driving conditions and situations, including road conditions such as unpaved roads and gradients, and change in vehicle speed, and change in tire characteristics.

In one aspect, the present disclosure provides an apparatus that is configured for measuring a vehicle weight, including at least one sensor for obtaining vehicle driving information, and a processor, in which a learning model using the vehicle driving information obtained through the at least one sensor as an input variable of the learning model is set, that estimates the vehicle weight using information related to a difference between a vehicle longitudinal motion state value learned by the set learning model and an actual vehicle longitudinal motion state value obtained through the at least one sensor.

In, an exemplary embodiment of the present disclosure, each of the learned vehicle longitudinal motion state value and the actual vehicle longitudinal motion state value may be a vehicle longitudinal acceleration or a value obtained by processing the vehicle longitudinal acceleration using a set model constant.

In another exemplary embodiment of the present disclosure, the learning model may include a vehicle longitudinal motion relational formula that defines a relationship between a vehicle longitudinal acceleration measurement value as the actual vehicle longitudinal motion state value and a longitudinal acceleration learning value as the learned vehicle longitudinal motion state value, and the processor is configured to determine the vehicle weight from a parameter associated with the longitudinal acceleration learning value in the vehicle longitudinal motion relational formula.

In still another exemplary embodiment of the present disclosure, the longitudinal acceleration learning value in the vehicle longitudinal motion relational formula may include an acceleration component generated by a force generated by a vehicle drive system and a vehicle brake system, and a deceleration component generated by a vehicle drive resistance.

In yet another exemplary embodiment of the present disclosure, the processor is configured to determine the vehicle weight as a reciprocal of a parameter included in the acceleration component or a value obtained by multiplying the reciprocal of the parameter by a constant.

In still yet another exemplary embodiment of the present disclosure, the processor is configured to determine a sum of values obtained by applying a weight to the acceleration component and the deceleration, respectively, as the longitudinal acceleration learning value.

In a further exemplary embodiment of the present disclosure, the deceleration component may include at least one of a deceleration component generated by an aerodynamic drag in proportion to a square of a vehicle speed or a drive system speed, a deceleration component generated by a rolling resistance in proportion to the vehicle speed or the drive system speed, or a deceleration component that occurs at all times by the rolling resistance during traveling of a vehicle, according to a direction of the vehicle speed or the drive system speed.

In another further exemplary embodiment of the present disclosure, the processor is configured to determine a vehicle drag coefficient and a rolling resistance force along with the vehicle weight from a parameter included in the acceleration component and the deceleration components.

In still another further exemplary embodiment of the present disclosure, the processor is configured to perform a model parameter learning process of updating the parameter included in the acceleration component and the deceleration components using the difference between the longitudinal acceleration learning value and the longitudinal acceleration measurement value detected by the at least one sensor.

In yet another further exemplary embodiment of the present disclosure, the processor is configured to perform a model parameter learning process of updating a parameter of a vehicle longitudinal motion relational formula set in the learning model using the difference between the learned vehicle longitudinal motion state value and the actual vehicle longitudinal motion state value obtained by the at least one sensor, and may estimate the vehicle weight from the updated parameter of the vehicle longitudinal motion relational formula.

In still yet another further exemplary embodiment of the present disclosure, the input variable may include a vehicle speed or a drive system speed, a driving force or a driving torque for vehicle driving, and a braking force or a braking torque for vehicle braking.

In another aspect, the present disclosure provides a method for estimating a vehicle weight, including inputting vehicle driving information obtained through at least one sensor in a vehicle to a processor, determining a difference between a vehicle longitudinal motion state value learned by a learning model using the obtained vehicle driving information as an input variable of the learning model, and an actual vehicle longitudinal motion state value obtained through the at least one sensor, by the processor, performing model parameter learning for updating a parameter of a vehicle longitudinal motion relational formula set in the learning model using the determined difference, by the processor, and estimating the vehicle weight from the updated parameter of the vehicle longitudinal motion relational formula, by the processor.

In, an exemplary embodiment of the present disclosure, the performing of the model parameter learning may include stopping the model parameter learning process, based on determining that the vehicle is stationary, the vehicle has experienced wheel slip, or a vehicle lateral motion occurs.

In another exemplary embodiment of the present disclosure, the performing of the model parameter learning may include updating the parameter of the vehicle longitudinal motion relational formula so that the determined difference converges on 0 or is minimized.

Other aspects and exemplary embodiments of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a diagram showing a configuration of an apparatus that estimates a vehicle weight according to an exemplary embodiment of the present disclosure;

FIG. 2 is a flowchart showing a process of estimating a vehicle weight according to an exemplary embodiment of the present disclosure; and

FIG. 3 is a diagram showing a learning process of updating intermediate state variables and learning parameters in a method for estimating a vehicle weight according to an exemplary embodiment of the present disclosure.

### DETAILED DESCRIPTION

Hereinafter, embodiments of the present disclosure will be described with reference to the accompanying drawings. Specific structural or functional descriptions presented in the embodiments of the present disclosure are merely exemplified for describing embodiments according to the concept of the present disclosure, and embodiments according to the concept of the present disclosure may be implemented in various forms. Furthermore, the present disclosure should not be construed as limited to the embodiments described in the present specification, but should be understood to include all modifications, equivalents, or substitutes included in the concept and technical scope of the present disclosure.

It will be understood that, although the terms “first”, “second”, etc. may be used herein to describe various elements, these elements should not be limited by these terms. These terms are only used to distinguish one element from another. For example, a first element may be termed a second element, and similarly, a second element may be termed a first element, without departing from the scope of the exemplary embodiments of the present disclosure.

Furthermore, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers will be used throughout the drawings to refer to the same or like portions. The terminology used herein is for describing particular embodiments only and is not intended to limit exemplary embodiments of the disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure relates to an apparatus configured for measuring a vehicle weight based on model parameter learning, and a method therefor. In detail, the present disclosure relates to an apparatus configured for estimating a vehicle weight by use of speed, acceleration and torque command information of the vehicle, obtained during vehicle traveling as input variables for model parameter learning and weight estimation, and a method therefor.

According to an exemplary embodiment of the present disclosure, vehicle weight information may be estimated based on a state value error which is a difference between a vehicle motion state value measured by a sensor and a vehicle motion state value obtained according to a predetermined learning process. The vehicle motion state value may include a vehicle longitudinal motion state value, and may include a vehicle longitudinal acceleration value.

According to an exemplary embodiment of the present disclosure, the vehicle weight information may be estimated based on a longitudinal acceleration error which is a difference between a longitudinal acceleration measurement value measured through a sensor, and a longitudinal acceleration learning value obtained according to a predetermined learning process.

In an exemplary embodiment of the present disclosure, the longitudinal motion state value is not limited to the vehicle longitudinal acceleration value, that is, the longitudinal acceleration itself, and as will be described later, a value obtained by processing the longitudinal acceleration through a model constant, instead of the longitudinal acceleration value, may be used to estimate the vehicle weight.

To solve the conventional problems, techniques for estimating a vehicle weight using a driving torque of a vehicle and a detection value of an acceleration sensor provided in the vehicle without additional cost have been provided.

However, such conventional weight estimation techniques include a limit in application due to inaccuracy of necessary input variables, such as torque information, a drive resistance model, and a drive system model. In particular, it is difficult to use the conventional weight estimation techniques in a case where a pitch motion of a vehicle occurs since the vehicle is traveling on a road with a gradient or the road surface is uneven.

In the conventional techniques for estimating a vehicle weight based on a model, it is not possible to estimate the vehicle weight in a deterministic manner since there are many unknown variables that fluctuate in real time compared to a single relational formula obtained from a vehicle dynamics model.

Thus, the present disclosure is directed to solve the problems of the conventional model-based weight estimation techniques, and presents a technique for estimating a vehicle weight in real time using a model parameter learning-based method.

According to the model parameter learning-based method used in an exemplary embodiment of the present disclosure, it is possible to estimate several unknown variables even with a single relational formula. In an exemplary embodiment of the present disclosure, by estimating unknown variables based on the recursive regression while using a model, it is possible to estimate multiple variables even with a single relational formula.

In such a technique, a model expression configured as a template used for regression is important. The template used for learning is important since how the model expression is set determines whether each variable can follow its actual value.

The recursive regression, especially, Recursive Least Squares (RLS), updates parameters to be used based on a single relational formula, and recalculates a combination of the parameters so that a square of an error of the relational formula value in a case where the updated parameters are used becomes the minimum. In the present way, all parameters may be updated to follow actual values, even in a case where there is only one measurable error.

In the following description, a method for estimating a vehicle weight according to an exemplary embodiment of the present disclosure will be described in detail.

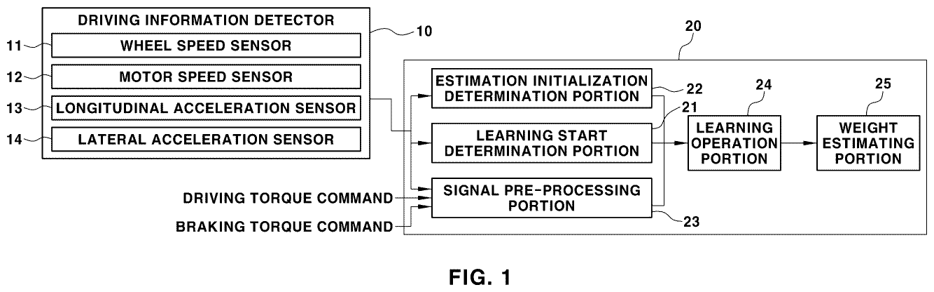

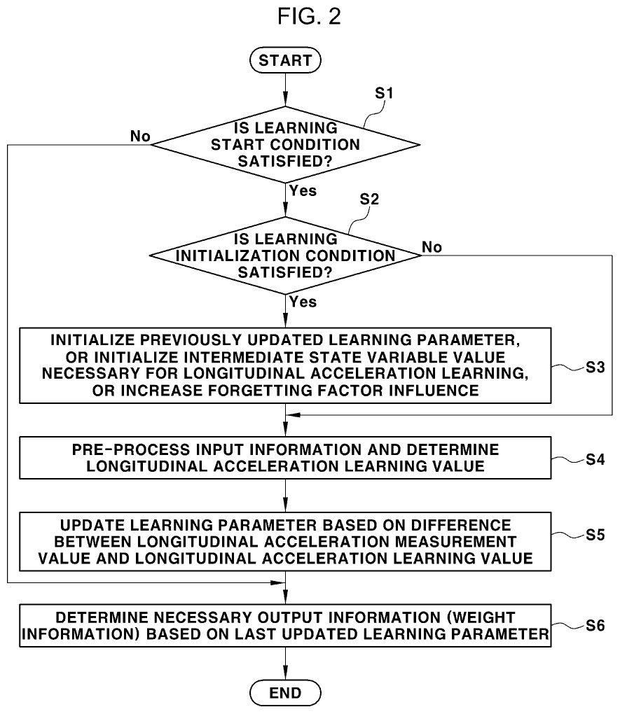

FIG. 1 is a diagram showing a configuration of an apparatus that estimates a vehicle weight according to an exemplary embodiment of the present disclosure, and FIG. 2 is a flowchart showing a process of estimating a vehicle weight according to an exemplary embodiment of the present disclosure.

As shown in the figures, the vehicle weight estimation apparatus according to the exemplary embodiment includes a driving information detector 10 which is configured to detect vehicle driving information necessary for weight estimation, and a processor 20 that is configured to perform longitudinal acceleration learning and weight estimation based on the vehicle driving information detected by the driving information detector 10.

The driving information detector 10 may include at least one sensor which is configured to detect vehicle driving information necessary for weight estimation, and for example, may include a wheel speed sensor 11 which is configured to detect a vehicle wheel speed, a motor speed sensor 12 which is configured to detect a speed of a motor as a drive unit that operates the vehicle, a longitudinal acceleration sensor 13 which is configured to detect a vehicle longitudinal acceleration, and a lateral acceleration sensor 14 which is configured to detect a lateral acceleration of the vehicle.

Furthermore, the processor 20 may include a learning start determination portion 21, an estimation initialization determination portion 22, a signal pre-processing portion 23, a learning operation portion 24, and a weight estimating portion 25.

In an exemplary embodiment of the present disclosure, the learning start determination portion 21 of the processor 20 is configured to determine whether a current vehicle driving state satisfies a learning start condition for weight estimation from at least one of input variables obtained and collected from the vehicle (see S1 in FIG. 2).

Here, the input variables may include information indicating the current vehicle driving state, that is, real-time vehicle driving information, which may be information obtained through sensors in the vehicle. The input variables for determining whether the learning start condition is satisfied may include the vehicle wheel speed and lateral acceleration.

In the case of the wheel speed, a value detected by the wheel speed sensor 11 disposed on the vehicle may be input to the learning start determination portion 21 and used to determine whether the learning start condition is satisfied. In the case of lateral acceleration, a value detected by the lateral acceleration sensor 14 disposed on the vehicle may be input to the learning start determination portion 21 and used to determine whether the learning start condition is satisfied.

In an exemplary embodiment of the present disclosure, learning may be executed based on a vehicle longitudinal motion relational formula, and force (or torque) input as a parameter of the relational formula for learning may be inaccurate in a case where the vehicle is stationary due to lack of information on a stopping friction force in friction braking (hydraulic braking), influence of a road gradient, or the like.

Furthermore, in an exemplary embodiment of the present disclosure, since learning for weight estimation is executed using a relational formula representing an acceleration/deceleration phenomenon of the vehicle as a template, the stationary state does not generate meaningful training information. Therefore, upon determining that the vehicle is stationary, learning may be stopped.

Furthermore, the vehicle speed information is input as a variable of the relational formula for learning, but in a case where wheel slip occurs, it is difficult to consider the vehicle speed information. Based on determining that the vehicle has experienced wheel slip, learning may be stopped. Furthermore, in a case where a vehicle lateral motion occurs, since the accuracy of the longitudinal motion relational formula may be reduced, learning may be stopped.

In an exemplary embodiment of the present disclosure, the learning start determination portion 21 may determine, from a wheel speed which is an input variable detected by the wheel speed sensor 11, whether the vehicle is stationary or whether the wheel slip has occurred, and may stop learning based on determining that the vehicle is stationary or that the wheel slip has occurred.

Furthermore, the learning start determination portion 21 may be configured to determine the vehicle lateral motion from another input variable, that is, a vehicle lateral acceleration detected by the lateral acceleration sensor 14, and may stop learning based on determining that there is the vehicle lateral motion.

Since the reliability of a learning result may be lowered in certain situations, the learning start determination portion 21 may be configured to determine whether to maintain, stop, or restart learning based on the input variable information, and may transmit the result of the determining or a request signal according to the result of the determining to the learning operation portion 24, so that the learning may be maintained, stopped, or restarted by the learning operation portion 24.

In an exemplary embodiment of the present disclosure, the learning operation portion 24 of the processor 20 executes learning as described later, and updates learning parameters for weight estimation in a direction in which an error between the learning result (longitudinal acceleration learning value) and a measurement result (longitudinal acceleration measurement value) is minimized.

Furthermore, after the error is minimized due to previous accumulated learning effects, it may be difficult to estimate the vehicle weight even in a case where the vehicle weight changes suddenly. Therefore, to reduce the accumulated learning effects, it is necessary to initialize an updated intermediate state variable and learning parameters to converge relatively rapidly on a new estimation target value.

Furthermore, to induce the conversion to the new value while gradually deviating from the accumulated effects, a method for increasing the influence of a forgetting factor may be used rather than fully initializing the learning parameters.

This is a method for dividing, in updating the intermediate state variable involved in updating the learning parameters, the intermediate state variable by the forgetting factor which is set to a value between 0 and 1. In Recursive Least Squares (RLS), the intermediate state variable may be referred to as a covariance matrix (P).

In an exemplary embodiment of the present disclosure, the above-mentioned learning initialization may be performed in a case where a preset learning initialization condition is satisfied. To the present end, the estimation initialization determination portion 22 may be configured to determine whether the current vehicle state meets the initialization condition from the vehicle state information collected from the vehicle (see S2 of FIG. 2).

Here, the vehicle state information includes at least one of gear information, starting state information, or door opening/closing information. The estimation initialization determination portion 22 may be configured to determine that the above-mentioned learning initialization condition is satisfied, in a case where a gear of the vehicle is changed to P, in a case where the vehicle is key-off or ignition-off, or in a case where a door is opened (including a case where the door is opened and then is closed).

Thus, based on determining that the estimation initialization determination portion 22 satisfies the learning initialization condition, the estimation initialization determination portion 22 requests the learning operation portion 24 to perform learning initialization, and the learning operation portion 24 initializes the intermediate state variable (P) and the learning parameters updated during the previous learning process to a preset initial value (see S3 in FIG. 2).

In an exemplary embodiment of the present disclosure, there may various considerations to determine whether learning initialization is necessary. For example, at least one of input of gear P, key-off, or door opening should occur to change the actual vehicle weight. Here, the learning initialization condition may be set to a condition where at least one of the input of gear P, the key off, or the door opening occurs.

Since the change in the vehicle weight due to fuel consumption or snow accumulation on the vehicle is small and a change rate is low, the change may be considered in the learning process even in a case where the above-mentioned initialization is not performed.

In the present way, since the degree of consideration of the previous accumulated information increases as the learning operation progresses, it is necessary to perform a process of initializing past operation values or applying a partial forgetting factor in a case where a predetermined event occurs, and the estimation initialization determination portion 22 is configured to determine whether to perform the present process (see S2 in FIG. 2).

In an exemplary embodiment of the present disclosure, the input variables necessary for learning may include a longitudinal acceleration, a drive system speed, a driving torque command, and a braking torque command of the vehicle as real-time vehicle driving information, and these input variables may be pre-processed before being used for learning (see S4 in FIG. 2). Here, the drive system speed may include a wheel speed or a motor speed.

In other words, the input variables are pre-processed by the signal pre-processing portion 23, and then, the result is input to the learning operation portion 24. After the input variables such as the longitudinal acceleration, the drive system speed, the driving torque command, and the braking torque command are input to the signal pre-processing portion 23, the signal pre-processing portion 23 may perform pre-processing for applying a filter to the input signal values to remove noise, or preventing the sizes of the signal values from exceeding preset operation ranges.

In an exemplary embodiment of the present disclosure, the pre-processing of the input signals may include a process of performing filtering for noise removal to reduce a noise effect, and a process of processing the input variables into a target form.

In other words, to obtain the vehicle speed information, the pre-processing of the input signals may include a process of converting the drive system speed information such as the wheel speed or the motor speed detected by the at least one sensors 11 and 12 into the vehicle speed information using a gear ratio, tire radius information, and the like, or a process of using the input variables converted in reverse of the above-mentioned process in a relational formula.

Since the method for obtaining the drive system speed information, for example, the vehicle speed information from a signal of the wheel speed sensor 11 is known to those skilled in the art, detailed description will be omitted.

In an exemplary embodiment of the present disclosure, the longitudinal acceleration may be pre-processed for removing the influence of a suspension or removing noise, etc., and the pre-processed longitudinal acceleration information may be input to the learning operation portion 24 as an input variable.

Force information used as an input variable in the learning operation portion 24 may include a driving force which is a propulsion force of the vehicle and a braking force acting in a direction opposite thereto, which may be converted from the torque information in the signal pre-processing portion 23.

The torque information going through the pre-processing procedure in the signal pre-processing portion 23 may include a driving torque and a braking torque, and the driving torque and the braking torque may be torque information determined by a driving force determination portion and a braking force determination portion (which are not shown).

Thus, the signal pre-processing portion 23 receives torque commands generated and output from the driving force determination portion and the braking force determination portion, that is, a driving torque command and a braking torque command as inputs thereof, and converts a driving torque and a braking torque corresponding to the command values into a driving force and a braking force which are input variables necessary for learning, and then inputs the result to the learning operation portion 24.

In the present way, the driving force and the braking force may be used as input variables along with the vehicle speed (see Formula 5), but the driving torque and the braking torque may be used as input variables along with the drive system speed (see Formula 4).

In summary, the input variables pre-processed by the signal pre-processing portion 23 and then input to the learning operation portion 24 may include the drive system speed or the vehicle speed, such as a wheel speed or a motor speed, the driving force or the driving torque converted from the driving torque command, and the braking force or the braking torque converted from the braking torque command.

In an exemplary embodiment of the present disclosure, the driving torque and the braking torque may be request torques according to a driving input of a driver in a normal vehicle. The driving torque is a torque generated by the drive unit that operates the vehicle, and the braking torque may be a total braking torque that brakes or decelerates the vehicle, i.e., a torque before distribution to a regenerative braking torque and a friction braking torque.

These driving torque and braking torque may be determined from real-time driving input values detected by sensors in the vehicle, i.e., an accelerator position sensor value (APS value) and a brake pedal sensor value (BPS value).

The sensors that detect the accelerator position sensor value and the brake pedal sensor value may include an accelerator position sensor (APS) which is configured to detect an accelerator position sensor value from a driver's accelerator operation (accelerator depression) and a brake pedal sensor (BPS) which is configured to detect a brake pedal sensor value from a driver's brake pedal operation (brake depression).

Since the method for determining the driving torque and the braking torque from the accelerator position sensor value and the brake pedal sensor value, which are vehicle driving information, is known to those skilled in the art, detailed description thereof will be omitted.

In a normal vehicle, to generate a driving force and a braking force corresponding to the determined driving torque and braking torque and to apply them to wheels, a processor is configured to output a driving torque command and a braking torque command based on the driving torque and the braking torque as command values according to respective situations, the operation of the drive unit that operates the vehicle according to the driving torque command is controlled, and regenerative braking of the motor and the operation of a friction brake is controlled according to the braking torque command.

The learning operation portion 24 maintains, stops, or restarts learning according to the determination result in the learning start determination portion 21, and performs learning initialization according to the determination result in the estimation initialization determination portion 22 (see S3 in FIG. 2).

Furthermore, the learning operation portion 24 receives input variables that are pre-processed in a form of information necessary for learning in the signal pre-processing portion 23, and updates a learning parameter by the recursive regression (see S5 in FIG. 2).

Then, the weight estimating portion 25 estimates the vehicle weight based on the learning parameters (see S6 in FIG. 2). In the instant case, the weight information may be determined directly from the learning parameters as described later. Alternatively, the weight estimating portion 25 may be configured to determine weight information converted by a preset formula using an input learning parameter, instead of directly determining the weight information from the learning parameters.

For example, in a case where the learning parameter is a reciprocal of a vehicle equivalent moment of inertia, a weight estimation value may be obtained by multiplying the reciprocal of the vehicle equivalent moment of inertia by a constant using wheel radius information.

In the above description, an example in which the processor 20 is a component of the learning start determination portion 21, the estimation initialization determination portion 22, the signal pre-processing portion 23, the learning operation portion 24, and the weight estimating portion 25 has been described, but the learning start determination portion, the estimation initialization determination portion, the signal pre-processing portion, the learning operation portion, and the weight estimating portion may be individual processors, respectively. In the instant case, the processor 20 shown in FIG. 1 may be a generic term encompassing such individual processors.

The processor 20 may include an electronic control unit (ECU) that is configured to perform weight estimation in the vehicle. The processor 20 may include one or more cores, and may include a processor for data analysis and deep learning of a central processing unit (CPU), a general purpose graphics processing unit (GPGPU), a general purpose graphics processing unit, a tensor processing unit (TPU), an application processor (AP), and the like. One or more processors 20 may perform control for processing input data in accordance with a predetermined operating rule or an artificial intelligence model stored in a memory. In a case where one or more processors 20 are dedicated to artificial intelligence, the dedicated artificial intelligence processor may be designed with a hardware structure which is specific to processing of a specific artificial intelligence model.

The processor 20 may read a computer program or instructions stored in the memory and perform learning start determination, initialization of intermediate state variables and learning parameters, signal pre-processing, learning operations, and weight estimation according to the exemplary embodiment of the present disclosure. Furthermore, the vehicle weight estimation apparatus may further include a memory. The memory may store a variety of information and setting data necessary for weight estimation according to the exemplary embodiment of the present disclosure. The memory may include at least one storage medium among a flash memory, a hard disk, a multimedia card micro type memory, a card type memory (for example, SD memory, XD memory or the like), a random access memory (RAM), a static random access memory (SRAM), a read-only memory (ROM), an electrically erasable programmable read-only memory (EEPROM), a programmable rear-only memory (PROM), a magnetic memory, a magnetic disk, and an optical disc. The memory may also include any form of computer readable recording medium known in the art to which the present disclosure belongs. The above-mentioned memories are merely exemplary, and the present disclosure is not limited thereto.

Hereinafter, a configuration of a learning loop performed by the learning operation portion, and a learning method and a process thereof will be described.

In an exemplary embodiment of the present disclosure, a longitudinal motion relational formula which is a model used in parameter learning and updating, and weight estimation may be determined from the following formulas.

$${a}_{meas} \approx {r}_{w} {\dot{ω}}_{w} + g sin θ \qquad [ Formula 1 ]$$

In Formula 1, aₘₑₐₛ represents an actual longitudinal acceleration measurement value of a vehicle (referred to hereinafter as a “measured longitudinal acceleration”) measured by the longitudinal acceleration sensor 13, and r_{w} represents a wheel radius of the vehicle. Furthermore, ω_{w} represents a wheel speed of the vehicle, \dot{ω}_{w} is a wheel acceleration which is a derivative of the wheel speed, g represents the gravitational acceleration, and θ is a road gradient of a road on which the vehicle is traveling.

As shown in Formula 1, the measured longitudinal acceleration may be expressed as a function of the wheel speed and the road gradient. According to Formula 1, which represents the measured longitudinal acceleration, the measured longitudinal acceleration which is the actual longitudinal acceleration measurement value represents a vehicle longitudinal motion including the influence of the road gradient.

Furthermore, the product of the equivalent inertia of the vehicle and the wheel acceleration may be expressed as Formula 2.

$${J}_{v} {\dot{ω}}_{w} = {T}_{acc} - {R}_{aero} {ω}_{w}^{2} - {R}_{res} sgn ( {ω}_{w} ) - {mgr}_{w} sin θ \qquad [ Formula 2 ]$$

In Formula 2, “Jv” represents a vehicle equivalent inertia, “Rₐₑᵣₒ” represents an equivalent aerodynamic drag coefficient, and “Rᵣₑₛ” represents an equivalent drag coefficient. “T_{acc}” represents a propulsion torque of the vehicle, which may be a driving torque or a braking torque depending on a vehicle driving state. “m” represents a vehicle weight, and “sgn(x)” represents a value of +1 when x>0, and −1 when x<0.

Furthermore, by multiplying each term of Formula 2 by

$$\frac{{γ}_{w}}{{J}_{v}} ,$$

Formula 3 may be determined.

$${r}_{w} {\dot{ω}}_{w} + \frac{{mr}_{w}^{2}}{{J}_{v}} g sin θ = \frac{{r}_{w}}{{J}_{v}} {T}_{acc} - \frac{{r}_{w} {R}_{aero}}{{J}_{v}} {ω}_{w}^{2} - \frac{{r}_{w} {R}_{rex}}{{J}_{v}} sgn ( {ω}_{w} ) \qquad [ Formula 3 ]$$

Here, if

$$\frac{{mr}_{w}^{2}}{{J}_{v}} = 1 ,$$

the left side of Formula 3 becomes the measured acceleration according to Formula 1, and therefore, Formula 3 may be expressed as Formula 4.

$${a}_{meas} = \frac{{r}_{w}}{{J}_{v}} {T}_{acc} - \frac{{r}_{w} {R}_{aero}}{{J}_{v}} {ω}_{w}^{2} - \frac{{r}_{w} {R}_{res}}{{J}_{v}} sgn ( {ω}_{w} ) \qquad [ Formula 4 ]$$

Furthermore, Formula 4 may be expressed as Formula 5.

$${a}_{meas} = \frac{1}{m} {F}_{acc} - \frac{ρ {AC}_{d}}{2 m} {V}^{2} - \frac{{F}_{res}}{m} sgn ( V ) \qquad [ Formula 5 ]$$

In Formula 5, “F_{acc}” represents a propulsion of the vehicle, which may be a driving force or a braking force depending on the vehicle driving state. Furthermore, “ρ” represents an air density, “A” represents a front area of the vehicle, “C_{d}” represents an aerodynamic drag coefficient (drag coefficient), V represents a vehicle speed, and “Fᵣₑₛ” represents a rolling resistance force acting on the vehicle.

In an exemplary embodiment of the present disclosure, in a case where Formula 5 is the longitudinal motion relational formula (longitudinal acceleration relational formula) used for parameter learning and updating along with the weight estimation of the vehicle, and when “aₘₑₐₛ” is a measured longitudinal acceleration,

$$\frac{1}{m} {F}_{acc} - \frac{ρ {AC}_{d}}{2 m} {V}^{2} - \frac{{F}_{res}}{m} sgn ( V )$$

which is the right side of the longitudinal motion relational formula may be defined as a longitudinal acceleration learning value (referred to hereinafter as a “learning longitudinal acceleration”).

Furthermore, the learning acceleration which is the right side of the relational formula may be expressed as a determinant of

$$[ \begin{matrix}\frac{1}{m} - & \frac{ρ {AC}_{d}}{2 m} - & \frac{{F}_{res}}{m} ]\end{matrix} [ {\begin{matrix}{F}_{acc} & {V}^{2} & sgn ( V ) ]\end{matrix}}^{T} .$$

In the determinant

$$[ \begin{matrix}\frac{1}{m} - & \frac{ρ {AC}_{d}}{2 m} - & \frac{{F}_{res}}{m} ]\end{matrix}$$

may be defined as a learning parameter, and is an input variable for weight estimation.

In an exemplary embodiment of the present disclosure, in a case where the learning is performed to update and learn the parameter

$$[ \begin{matrix}\frac{1}{m} - & \frac{ρ {AC}_{d}}{2 m} - & \frac{{F}_{res}}{m} ]\end{matrix} ,$$

since the learning longitudinal acceleration which is the right side in Formula 5 is determined as a function of the parameter, the parameter learning process may be considered as a longitudinal acceleration learning process.

As described above, Formula 5 may be used as the longitudinal motion relational formula, but instead, Formula 4 may be used as the longitudinal motion relational formula. Formulas 4 and 5 are exemplary, and the disclosure is not limited to the case where the longitudinal motion relational formula is Formula 4 or 5.

In an exemplary embodiment of the present disclosure, a drive system which is considered in the longitudinal motion relational formula includes both linear and rotary drive systems. Since these systems has such a relationship that they may be converted to each other only by multiplication of a model constant, whichever is used for the longitudinal acceleration learning and weight estimation, and may be considered to be within the scope of the present disclosure. Furthermore, the use of other terms which may be simply converted by multiplication of a constant in the longitudinal motion relational formula is also within the scope of the present disclosure.

Furthermore, in the above relational formula, the right side is expressed as a term of the driving force/braking force, a term of the aerodynamic drag, and a term of the rolling resistance force, but the present disclosure may include a relational formula that utilizes the term of the driving force/braking force, and at least one of a term of the aerodynamic drag proportional to the square of the vehicle speed, a term of the rolling resistance force proportional to the vehicle speed, or a constant term of the rolling resistance based on the vehicle speed direction (sgn (V)). Here, instead of the vehicle speed, the drive system speed which may be measured by the at least one sensor 11 or 12, such as a wheel speed or a motor speed, may be used.

In a process of determining the longitudinal acceleration learning value expressed as the right side of Formula 4 or Formula 5, the longitudinal learning value which is the right side of the longitudinal motion relational formula may include an acceleration component generated by a force (or torque) generated by the drive system and the brake system, a deceleration component (Aₐ) that occurs in proportion to the square of the vehicle speed (or the drive system speed such as the wheel speed or the motor speed) by the aerodynamic drag, and a deceleration component (Aᵣ) that occurs at all times during vehicle operation according to the direction of the vehicle speed (or the drive system speed such as the wheel speed or the motor speed) by the rolling resistance.

Here, the longitudinal acceleration learning value may be obtained by the sum of the acceleration component and the deceleration component (Aₐ, Aᵣ). Furthermore, the force or torque generated by the drive system and the brake system refers to a force or torque generated by the drive unit and the brake unit of the vehicle.

Alternatively, the longitudinal learning value which is the right side of the longitudinal motion relational formula may include an acceleration component generated by the force (or torque) by the drive system and the brake system, a deceleration component (A₂) that occurs in proportion to the square of the vehicle speed (or the drive system speed such as the wheel speed or the motor speed) by the aerodynamic drag, a deceleration component (A₁) that occurs in proportion to the vehicle speed (or the drive system speed such as the wheel speed or motor speed) by the rolling resistance, and a deceleration component (A₀) that occurs at all times during vehicle traveling according to the direction of the vehicle speed (or the drive system speed such as the wheel speed or motor speed) by the rolling resistance. In the instant case, the longitudinal acceleration learning value may be similarly determined by the sum of the acceleration component and the deceleration component (A₂, A₁, A₀).

In summary, the longitudinal learning value which is the right side of the longitudinal motion relational formula may include the acceleration component generated by the force (or torque) from the drive system and the brake system, and at least one of the plurality of acceleration components (A₂, A₁, A₀) based on the drive resistance. Here, the longitudinal acceleration learning value may be determined by the sum of the used acceleration component and deceleration component.

Furthermore, in a process of determining the longitudinal acceleration learning value, the sum of values obtained by applying a weight (parameter) to the used acceleration component and deceleration components (A₂, A₁, A₀), respectively, may be determined as the longitudinal acceleration learning value.

A significant advantage of the present method is that the effect of the road gradient (θ) is excluded. The advantage is based on that the measured longitudinal acceleration (aₘₑₐₛ) is already measured to consider an effect of the road gradient, as in Formula 1, and the measured longitudinal acceleration corresponds to the right side, which does not include the road gradient as a variable, as in formulas 3, 4, and 5 (the term including the gradient θ is removed from Formula 3).

In an exemplary embodiment of the present disclosure, the learning operation portion 24 is configured to determine the learning longitudinal acceleration, which is the longitudinal acceleration learning value, based on a real-time input variable and a learning parameter. Here, the learning longitudinal acceleration may be determined as the product of the parameter and the input variable, that is,

$$[ \begin{matrix}\frac{1}{m} - & \frac{ρ {AC}_{d}}{2 m} - & \frac{{F}_{res}}{m} ]\end{matrix} [ {\begin{matrix}{F}_{acc} & {V}^{2} & sgn ( V ) ]\end{matrix}}^{T} .$$

Furthermore, in an exemplary embodiment of the present disclosure, the parameter is updated as a function of a longitudinal acceleration error which is a difference between the measured longitudinal acceleration and the learning longitudinal acceleration. Here, the function for parameter updating is in charge of the intermediate state variable (P).

In the recursive least-squares method, the intermediate state variable (covariance matrix, P) is updated as shown in Formula 6, and after the update, the learning parameter is updated using the intermediate state variable (“P after update”), the input variable, and the longitudinal acceleration error.

$$P after update = ( P before update ) - \frac{\begin{matrix}( P before update ) ( input variable ) \\ {( input variable )}^{T} ( P before update )\end{matrix}}{1 + {( input variable )}^{T} ( P before update ) ( input variable )} \qquad [ Formula 6 ]$$

$$( Parameter after update ) = parameter before update + ( P after update ) ( input variable ) ( longitudinal acceleration error ) \qquad [ Formula 7 ]$$

In Formula 6, “P after update” represents an intermediate state variable after update, and “P before update” represents an intermediate state variable before update.

The method for updating the intermediate state variable and learning parameter shown in formulas 6 and 7 is merely exemplary, and the present disclosure is not limited thereto. Any method for updating the intermediate state variable and learning parameter so that the difference between the measured longitudinal acceleration and the learning longitudinal acceleration, which is the longitudinal acceleration error, converges on zero or is minimized may be used.

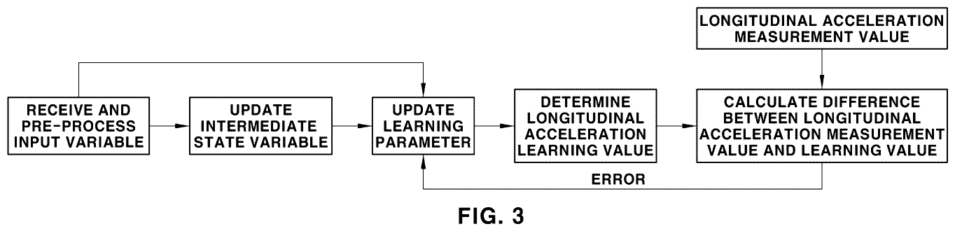

FIG. 3 is a diagram showing a learning process of updating an intermediate state variable and a learning parameter in a method for estimating a vehicle weight according to an exemplary embodiment of the present disclosure.

As shown in FIG. 3, in a case where an input variable pre-processed in the signal pre-processing portion 23 of the processor 20 is input to the learning operation portion 24, the learning operation portion 24 updates an intermediate state variable based on the input variable information, and updates a learning parameter using the updated intermediate state variable and a longitudinal acceleration error which is a feedback value.

Furthermore, the learning operation portion 24 is configured to determine a longitudinal acceleration learning value, that is, a learning longitudinal acceleration using the updated learning parameter, and is configured to determine the longitudinal acceleration error which is a difference between the determined learning longitudinal acceleration and a measured longitudinal acceleration which is a real-time longitudinal acceleration measurement value. Here, the determined longitudinal acceleration error is used as the feedback value for updating the next learning parameter as described above.

After the learning parameter is updated as described above, the weight estimation portion 25 of the processor 20 is configured to determine and is configured to determine a vehicle weight based on the updated learning parameter. In a case where the vehicle weight cannot be determined directly from the parameter after update according to definition of the relational formula, the vehicle weight may be determined based on the parameter information after update.

In an exemplary embodiment of the present disclosure, since the first element of the learning parameter

$$[ \begin{matrix}\frac{1}{m} - & \frac{ρ {AC}_{d}}{2 m} - & \frac{{F}_{res}}{m} ]\end{matrix}$$

(parameter included in the term of the acceleration component in the relational formula) is a reciprocal of the vehicle weight, the vehicle weight may be determined by taking the reciprocal of the first element.

In addition to the vehicle weight information, other necessary output information, for example, a drag coefficient, a rolling resistance force (Fᵣₑₛ), and the like may also be determined based on the updated learning parameter in an exemplary embodiment of the present disclosure.

According to the vehicle weight estimation apparatus and method of the present disclosure, it is possible to estimate the vehicle weight using the acceleration sensor and the wheel speed sensor provided in the vehicle without using additional sensors, preventing the problem of cost increase. Furthermore, since the estimated weight information is used for various controls in the vehicle, it is possible to improve vehicle performance and control performance.

Furthermore, according to an exemplary embodiment of the present disclosure, it is possible to provide stable weight estimation performance under all driving conditions and situations, including road conditions such as unpaved roads, and road gradients, and change in vehicle speed, and change in tire characteristics. It is possible to estimate the vehicle weight independent of road gradients based on the longitudinal acceleration relational formula of the vehicle.

Furthermore, the vehicle weight estimation apparatus and method according to an exemplary embodiment of the present disclosure are useful to detect trailer installation in the vehicle in a case where the trailer is frequently installed in a country or region, and thus, it is possible to perform optimal vehicle control according to whether or not the trailer is installed, improving vehicle merchantability.

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

What is claimed is:

1. An apparatus that measures a vehicle weight, the apparatus comprising:
at least one sensor for obtaining vehicle driving information; and
a processor, in which a learning model using the vehicle driving information obtained through the at least one sensor as an input variable of the learning model is set, and that estimates the vehicle weight using information related to a difference between a vehicle longitudinal motion state value learned by the set learning model and an actual vehicle longitudinal motion state value obtained through the at least one sensor.

2. The apparatus of claim 1, wherein each of the learned vehicle longitudinal motion state value and the actual vehicle longitudinal motion state value is a vehicle longitudinal acceleration or a value obtained by processing the vehicle longitudinal acceleration using a set model constant.

3. The apparatus of claim 1,
wherein the learning model includes a vehicle longitudinal motion relational formula that defines a relationship between a vehicle longitudinal acceleration measurement value as the actual vehicle longitudinal motion state value and a longitudinal acceleration learning value as the learned vehicle longitudinal motion state value, and
wherein the processor determines the vehicle weight from a parameter associated with the longitudinal acceleration learning value in the vehicle longitudinal motion relational formula.

4. The apparatus of claim 3, wherein the longitudinal acceleration learning value in the vehicle longitudinal motion relational formula includes:
an acceleration component generated by a force generated by a vehicle drive system and a vehicle brake system; and
a deceleration component generated by a vehicle drive resistance.

5. The apparatus of claim 4, wherein the processor determines the vehicle weight as a reciprocal of a parameter included in the acceleration component or a value obtained by multiplying the reciprocal of the parameter by a constant.

6. The apparatus of claim 4, wherein the processor determines a sum of values obtained by applying a weight to the acceleration component and the deceleration, respectively, as the longitudinal acceleration learning value.

7. The apparatus of claim 4, wherein the deceleration component includes at least one of:
a deceleration component generated by an aerodynamic drag in proportion to a square of a vehicle speed or a drive system speed;
a deceleration component generated by a rolling resistance in proportion to the vehicle speed or the drive system speed; or
a deceleration component that occurs at all times by the rolling resistance during traveling of a vehicle, according to a direction of the vehicle speed or the drive system speed.

8. The apparatus of claim 7, wherein the processor determines a vehicle drag coefficient and a rolling resistance force along with the vehicle weight from a parameter included in the acceleration component and the deceleration components.

9. The apparatus of claim 4, wherein the processor performs a model parameter learning process of updating a parameter included in the acceleration component and the deceleration components using a difference between the longitudinal acceleration learning value and the longitudinal acceleration measurement value detected by the at least one sensor.

10. The apparatus of claim 1, wherein the processor performs a model parameter learning process of updating a parameter of a vehicle longitudinal motion relational formula set in the learning model using the difference between the learned vehicle longitudinal motion state value and the actual vehicle longitudinal motion state value obtained by the at least one sensor, and estimates the vehicle weight from the updated parameter of the vehicle longitudinal motion relational formula.

11. The apparatus of claim 1, wherein the input variable includes a vehicle speed or a drive system speed, a driving force or a driving torque for vehicle driving, and a braking force or a braking torque for vehicle braking.

12. A method for estimating a vehicle weight, the method comprising:
inputting vehicle driving information obtained through at least one sensor in a vehicle to a processor;
determining a difference between a vehicle longitudinal motion state value learned by a learning model using the obtained vehicle driving information as an input variable of the learning model, and an actual vehicle longitudinal motion state value obtained through the at least one sensor, by the processor;
performing model parameter learning for updating a parameter of a vehicle longitudinal motion relational formula set in the learning model using the determined difference, by the processor; and
estimating the vehicle weight from the updated parameter of the vehicle longitudinal motion relational formula, by the processor.

13. The method of claim 12, wherein each of the learned vehicle longitudinal motion state value and the actual vehicle longitudinal motion state value is a vehicle longitudinal acceleration or a value obtained by processing the vehicle longitudinal acceleration using a set model constant.

14. The method of claim 12,
wherein the learning model includes a vehicle longitudinal motion relational formula that defines a relationship between a vehicle longitudinal acceleration measurement value as the actual vehicle longitudinal motion state value and a longitudinal acceleration learning value as the learned vehicle longitudinal motion state value, and
wherein the estimating of the vehicle weight includes determining the vehicle weight from a parameter associated with the longitudinal acceleration learning value in the vehicle longitudinal motion relational formula, by the processor.

15. The method of claim 14, wherein the longitudinal acceleration learning value in the vehicle longitudinal motion relational formula comprises:
an acceleration component generated by a force generated by a vehicle drive system and a vehicle brake system; and
a deceleration component generated by a vehicle drive resistance.

16. The method of claim 15, further comprising:
determining, by the processor, the vehicle weight as a reciprocal of a parameter included in the acceleration component or a value obtained by multiplying the reciprocal of the parameter by a constant.

17. The method of claim 15, wherein the deceleration component comprises at least one of:
a deceleration component generated by an aerodynamic drag in proportion to a square of a vehicle speed or a drive system speed;
a deceleration component generated by a rolling resistance in proportion to the vehicle speed or the drive system speed; or
a deceleration component that occurs at all times by the rolling resistance during traveling of the vehicle, according to a direction of the vehicle speed or the drive system speed.

18. The method of claim 15, further comprising:
performing, by the processor, a model parameter learning process of updating a parameter included in the acceleration component and the deceleration components using a difference between the longitudinal acceleration learning value and the longitudinal acceleration measurement value detected by the at least one sensor.

19. The method of claim 12, wherein the performing of the model parameter learning includes stopping the model parameter learning, based on determining that the vehicle is stationary, the vehicle has experienced wheel slip, or a vehicle lateral motion occurs.

20. The method of claim 12, wherein the performing of the model parameter learning includes updating the parameter of the vehicle longitudinal motion relational formula so that the determined difference converges on 0 or is minimized.
